(19) United States
(12) Patent Application Publication
(10) Pub. No.: US 2025/0349113 A1
(43) Pub. Date: Nov. 13, 2025

(54) METHOD FOR PERFORMING UNLEARNING OF PEOPLE IN A GENERATIVE MODEL AND COMPUTING DEVICE FOR PERFORMING THE SAME

(71) Applicant: University-Industry Cooperation Group of Kyung Hee University, Gyeonggi-do (KR)

(72) Inventors: GYEONG MOON PARK, Gyeonggi-do (KR); TAE YOUNG LEE, Incheon (KR); JU WON SEO, Gyeonggi-do (KR)

(21) Appl. No.: 18/925,176

(22) Filed: Oct. 24, 2024

(30) Foreign Application Priority Data
May 7, 2024 (KR) 10-2024-0060152

(51) Int. Cl. G06V 10/778; G06V 10/82; G06V 40/16; G06V 40/50

(52) U.S. Cl. CPC G06V 10/778; G06V 10/82; G06V 40/16; G06V 40/50

(57) ABSTRACT

A method of performing unlearning of people in a generative model includes inputting a source image including a face of a person to be unlearned in a pre-learned generative model into an encoder to extract a source latent vector in a latent space, setting a target latent vector so that the identity is different from that of a person corresponding to the source latent vector in the latent space, and performing unlearning to remove the identity of the person in the pre-learned model based on the source latent vector and the target latent vector.

### CROSS-REFERENCE TO RELATED APPLICATION AND CLAIM OF PRIORITY

This application claims the benefit under 35 USC § 119 of Korean Patent Application No. 10-2024-0060152, filed on May 7, 2024, in the Korean Intellectual Property Office, the entire disclosure of which are incorporated herein by reference for all purposes.

### BACKGROUND

### 1. Technical Field

The examples of the present invention are related to a technology for performing unlearning of people in a generative model.

### 2. Background Art

Recently, the performance of AI generative models has been rapidly developing, and they are attracting much attention. However, the development of these generative models causes concerns about personal information. For example, images or videos of specific individuals (for example, celebrities, sports players, politicians, entrepreneurs, etc.) can be created through the generative models like deep fakes, so problems of personal information being exposed without permission occur.

Accordingly, in order to solve the personal information problems in the generative models, researches on unlearning (machine unlearning) have been conducted. Unlearning aims to forget the knowledge already acquired in a pre-learned artificial intelligence model or reduce the influence of specific learning data. However, most previous unlearning researches often require access to the entire learning data set, but there are problems in that not only it is difficult to obtain the entire learning data set, but also the amount of computation to perform unlearning is large.

### SUMMARY

The examples of the present invention are to provide a new technique enabling unlearning the identity of people in a pre-learned generative model only with one source image.

The method of performing unlearning of people in a generative model according to one example disclosed, is a method performed in a computing device equipped with one or more processors, and a memory storing one or more programs executed by the one or more processors, and includes inputting a source image including a face of a person to be unlearned in a pre-learned generative model into an encoder to extract a source latent vector in a latent space; setting a target latent vector so that the identity is different from that of a person corresponding to the source latent vector in the latent space; and performing unlearning to remove the identity of the person in the pre-learned model based on the source latent vector and the target latent vector.

The setting a target latent vector may include obtaining a mean latent vector in the latent space by the encoder; and setting a target latent vector based on the source latent vector and the mean latent vector.

The setting a target latent vector may include calculating an identity latent vector for the person by a difference between the source latent vector and the mean latent vector in the latent space; and setting a target latent vector in the opposite direction to the direction of the identity latent vector based on the mean latent vector.

The target latent vector (wₜ) may be set by the following equation.

$${w}_{t} = \overline{w} - d \cdot \frac{{w}_{id}}{{‖ {w}_{id} ‖}_{2}} \qquad ( Equation )$$

w̅: Mean latent vector
d: Pre-set distance control parameter
w_{id}: Identity latent vector
∥w_{id}∥₂: 2-norm distance (L2-norm) of identity latent vector

The performing unlearning, may include inputting the target latent vector into a first generator, which is a pre-learned generative model to output a target feature map; inputting the source latent vector into a second generator to output a source feature map; inputting the target feature map and the source feature map into a rendering model, respectively, to output a target generated image and a source generated image, respectively; and learning the second generator by a first loss pre-set based on the target feature map, the source feature map, the target generated image, and the source generated image, and the initial values of neural network parameters of the second generator may be set as same as values of neural network parameters of the learned first generator.

The first loss is a local unlearning loss, and may include a first local-related loss that makes the target feature map and the source feature map similar; a second local-related loss that makes the target generated image and the source generated image perceptually similar; and a third local-related loss that makes the identities of the target generated image and the source generated image similar.

The local unlearning loss (Local) may be represented by the following equation.

$${ℒ}_{local} ( {\hat{x}}_{u} , {\hat{x}}_{t} ) = {λ}_{L 2} {ℒ}_{L 2} ( {F}_{u} , {F}_{t} ) + {λ}_{per} {ℒ}_{per} ( {\hat{x}}_{u} , {\hat{x}}_{t} ) + {λ}_{id} {ℒ}_{id} ( {\hat{x}}_{u} , {\hat{x}}_{t} ) \qquad ( Equation )$$

Fᵤ: Source feature map
Fₜ: Target feature map
\hat{x}ᵤ: Source generated image
\hat{x}ₜ: Target generated image
[symbol] _{L2}(Fᵤ, Fₜ): First local-related loss
[symbol] ₚₑᵣ(\hat{x}ᵤ, \hat{x}ₜ): Second local-related loss
[symbol] _{id}(\hat{x}ᵤ, \hat{x}ₜ): Third local-related loss
λ_{L2}: Weighted value of the first local-related loss
λₚₑᵣ: Weighted value of the second local-related loss
λ_{id}: Weighted value of the third local-related loss

The performing unlearning may further include extracting one or more source peripheral latent vectors adjacent to the source latent vector in the latent space, and extracting one or more target peripheral latent vectors adjacent to the target latent vector; and learning the second generator by a second loss pre-set based on the source peripheral latent vector and the target peripheral latent vector.

The learning the second generator by a second loss may include inputting each of the target peripheral latent vectors into the first generator to output a target peripheral feature map, respectively; inputting each of the source peripheral latent vectors into the second generator to output a source peripheral feature map, respectively; inputting each of the target peripheral feature map into the rendering model to output a target peripheral generated image, respectively; and inputting each of the source peripheral feature map into the rendering model to output a source peripheral generated image, respectively.

The second loss is an adjacency-aware unlearning loss, and may include a first adjacency-related loss that makes the target peripheral feature map and the source peripheral feature map similar; a second adjacency-related loss that makes the target peripheral generated image and the source peripheral feature map similar; and a third adjacency-related loss that makes the identities of the target peripheral generated image and the source peripheral generated image similar.

The performing unlearning, may further include extracting random latent vectors from random noise in the latent space, and the extracting the source peripheral latent vectors may be extracting source peripheral latent vectors by scaling within a pre-set maximum radius in each direction to random latent vectors based on the source latent vector, and the extracting the target peripheral latent vectors may be extracting target peripheral latent vectors by scaling within a pre-set maximum radius in each direction to random latent vectors based on the target latent.

The performing unlearning may further include extracting random latent vectors unrelated to the source latent vector and the target latent vector among the random latent vectors of the latent space; and learning the second generator by a third loss pre-set based on the random latent vectors unrelated to the source latent vector and the target latent vector.

The learning the second generator by a third loss, may include outputting a first random generated image by making the unrelated random latent vector pass through the first generator and the rendering model; and outputting a second random generated image by making the unrelated random latent vector pass through the second generator and the rendering model.

The third loss is a global preservation loss, and may be a loss that makes the first random generated image and the second random generated image perceptually similar.

The computing device according to one example disclosed, includes one or more processors; a memory; and one or more programs, and is configured so that the one or more programs are stored in the memory, and are executed by the one or more processors, and the one or more programs include an instruction to input a source image including a face of a person to be unlearned in a pre-learned generative model into an encoder to output a source latent vector in the latent space; an instruction to set a target latent vector so that the identity is different from the person corresponding to the source latent vector in the latent space; and an instruction to perform unlearning to remove the identity of the person in the pre-learned model based on the source latent vector and the target latent vector.

The instruction to perform unlearning may include an instruction to input the target latent vector into a first generator, which is a pre-learned generative model to output a target feature map; an instruction to input the source latent vector into a second generator to output a source feature map; an instruction to input the target feature map and the source feature map into a rendering model, respectively, to output a target generated image and a source generated image, respectively; and an instruction to learn the second generator by a first loss pre-set based on the target feature map, the source feature map, the target generated image, and the source generated image, and the initial values of neural network parameters of the second generator may be set as same as values of neural network parameters of the learned first generator.

The instruction to perform unlearning may further include an instruction to extract one or more source peripheral latent vectors adjacent to the source latent vector in the latent space, and to extract one or more target peripheral latent vectors adjacent to the target latent vector; and an instruction to learn the second generator by a second loss pre-set based on the source peripheral latent vector and the target peripheral latent vector.

The instruction to perform unlearning may further include an instruction to extract random latent vectors in the latent space from random noise; an instruction to extract random latent vectors unrelated to the source latent vector and the target latent vector among the random latent vectors of the latent space; and an instruction to learn the second generator by a third loss pre-set based on the random latent vectors unrelated to the source latent vector and the target latent vector.

According to the disclosed examples, the identity of a person included in the source image can be removed in a pre-learned generative model only with one source image. Then, while maintain the identity of the corresponding person, images with different expressions or styles can be unlearned, and at the same time, it is possible to maintain the performance of the pre-learned generative model.

### BRIEF DESCRIPTION OF THE DRAWINGS

FIG. 1 is a block diagram for illustrating and describing a computing environment including a computing device suitable for use in illustrative examples

FIG. 2 is a diagram showing an overall framework for performing unlearning of prescribed people in a pre-learned generative model according to one example of the present invention

FIG. 3 is a diagram showing a part related to the un-identifying process among the overall framework of FIG. 2

FIG. 4 is a diagram showing a part related to the latent target unlearning process among the overall framework of FIG. 2

FIG. 5 is a diagram illustrating a state of setting a target latent vector based on a mean latent vector and a source latent vector in a latent space in one example of the present invention

FIG. 6 is a diagram showing a state of applying a local unlearning loss (L_{local}) in one example of the present invention

FIG. 7 is a diagram showing a state of applying an adjacency-aware unlearning loss) (L_{adj}) in one example of the present invention

FIG. 8 is a diagram showing a state of extracting a source peripheral latent vector using a random latent vector in a latent space according to one example of the present invention

FIG. 9 is a diagram showing a state of applying a global preservation loss) (L_{global}) in one example of the present invention

FIG. 10 is a flowchart to describe the method of performing unlearning of people in a pre-learned generative model according to one example of the present invention

### DETAILED DESCRIPTION

Hereinafter, specific embodiments of the present invention will be described with reference to drawings. The following detailed description is provided to help a comprehensive understanding of the methods, devices, and/or systems described in the present description. However, these are only examples, and the present invention is not limited thereto.

In describing the examples of the present invention, when it is judged that a detailed description of the prior art related to the present invention may unnecessarily obscure the gist of the present invention, the detailed description will be omitted. In addition, the terms described below are terms defined in consideration of their functions in the present invention, and may vary depending on the intention of the user or operator or custom or the like. Therefore, the definitions should be made based on the contents throughout the present description. The terms used in the detailed description are only for describing the examples of the present invention, and should never be limited. Unless clearly used otherwise, expressions in the singular form include the meaning of the plural form. In the present description, expressions such as “including” or “having” are intended to indicate certain characteristics, numbers, steps, operations, elements, parts or combinations thereof, and it should not be interpreted to exclude the existence or possibility of one or more other characteristics, numbers, steps, operations, elements, parts or combinations thereof other than those described.

In addition, the terms such as first, second, and the like may be used to describe various components, but the components should not be limited by the terms. The terms may be used for the purpose of distinguishing one component from other components. For example, without departing from the scope of the present invention, the first component may be named the second component, and similarly, the second component may also be named the first component.

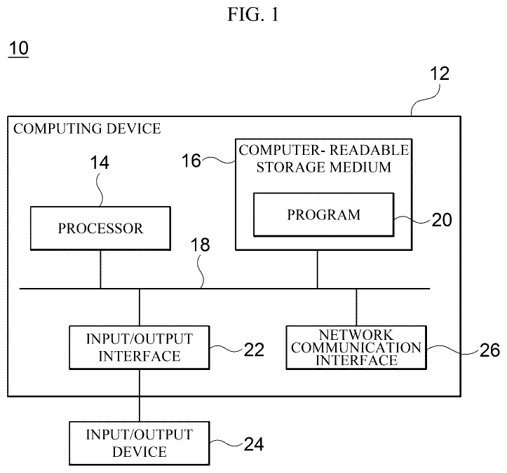

FIG. 1 is a block diagram for illustrating and describing a computing environment (10) including a computing device suitable for use in illustrative examples. In the illustrated example, each component may have different functions and capabilities other than those described below, and may include an additional component other than those described below.

The illustrated computing environment (10) includes a computing device (12). In one example, the computing device (12) may be a device for performing unlearning to a specific person (in other words, unlearning about a specific identity) in a pre-learned generative model. The generative model may be a model for generating an image (static image or video). The computing device (12) may be a device for performing unlearning on an image of a specific person from an image generated by the generative model. In this case, the generative model does not generate an image of the person who is the target of unlearning.

The computing device (12) includes at least one processor (14), a computer readable storage medium (16) and a communication bus (10). The processor (14) may make the computing device (12) to operate according to the illustrative example mentioned above. For example, the processor (14) may execute one or more programs stored in the computer readable storage medium (16). The one or more programs may include one or more computer executable instructions, and the computer executable instructions may be configurated to make the computing device (12) to perform operations according to the illustrative example, when executed by the processor (14).

The computer readable storage medium (16) is configurated to store a computer executable instruction or a program code, program data and/or other suitable forms of information. The program (20) stored in the computer readable storage medium (16) includes a set of instructions executable by the processor (14). In one example, the computer readable storage medium (16) may be a memory (volatile memory such as a random-access memory, non-volatile memory, or a suitable combination thereof), one or more magnetic disk storage devices, optical disk storage devices, flash memory devices, any other form of storage medium that can be accessed by the computing device (12) and store desired information, or a suitable combination thereof.

The communication bus (18) includes the processor (14) and the computer readable storage medium (16) and interconnects various other components of the computing device (12).

The computing device (12) may also include one or more input/output interfaces (22) to provide interfaces for one or more input/output devices (24) and one or more network communication interfaces (26). The input/output interfaces (22) and the network communication interfaces (26) are connected to the communication bus (18). The input/output devices (24) may be connected to other components of the computing device (12) through the input/output interfaces (22). The exemplary input/output devices (24) may include a pointing device (mouse or trackpad, etc.), a keyboard, a touch input device (touchpad or touchscreen, etc.), a voice or sound input device, various kinds of input devices such as sensor devices and/or photographing devices, and/or output devices such as a display device, a printer, a speaker, and/or a network card. The exemplary input/output device (24) is one component constituting the computing device (12), and may be included inside the computing device (12), and may be connected to the computing device (12) by a separate device distinct from the computing device (12).

In the example to be disclosed, only with one input image (source image) for a specific person, unlearning (machine unlearning) for the corresponding person may be performed in a pre-learned generative model. Herein, unlearning for a certain person may be achieved by converting the input image including the corresponding person into a source latent vector, which is a latent vector in a latent space, and changing the image corresponding to the source latent vector into an image corresponding to the target latent vector in the latent space.

At this time, the target latent vector should be appropriately set in the latent space. In other words, the target latent vector should be set so that the image corresponding to the target latent vector is not similar to the person in the input image (so that the identity is different). Hereinafter, the process for setting the target latent vector in the latent space may be referred to as the un-identifying process.

In addition, in the process of converting the image corresponding to the source latent vector into an image corresponding to the target latent vector, in order to convert the image effectively without damaging the performance of the pre-trained generative model, a total of three kinds of loss functions (L_{local}, L_{adj}, L_{global}) may be applied. In other words, the pre-learned generative model should be made to generate an image corresponding to another latent vector, while preventing from generating an image corresponding to a specific latent vector, and for this, a total of 3 kinds of loss functions (L_{local}, L_{adj}, L_{global}) were introduced. Hereinafter, the process of applying these 3 kinds of loss functions may be referred to as a latent target unlearning process.

As such, the process of performing unlearning (machine unlearning) for a certain person in a pre-learned generative model may include an un-identifying process and a latent target unlearning process.

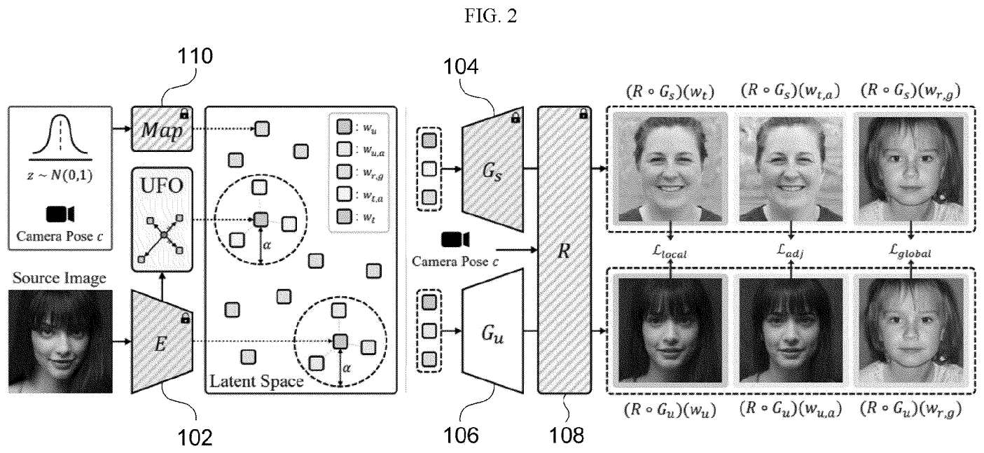

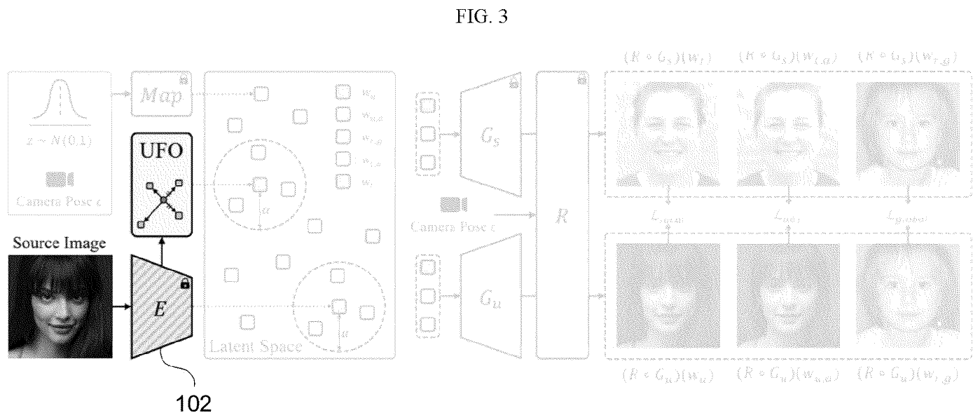

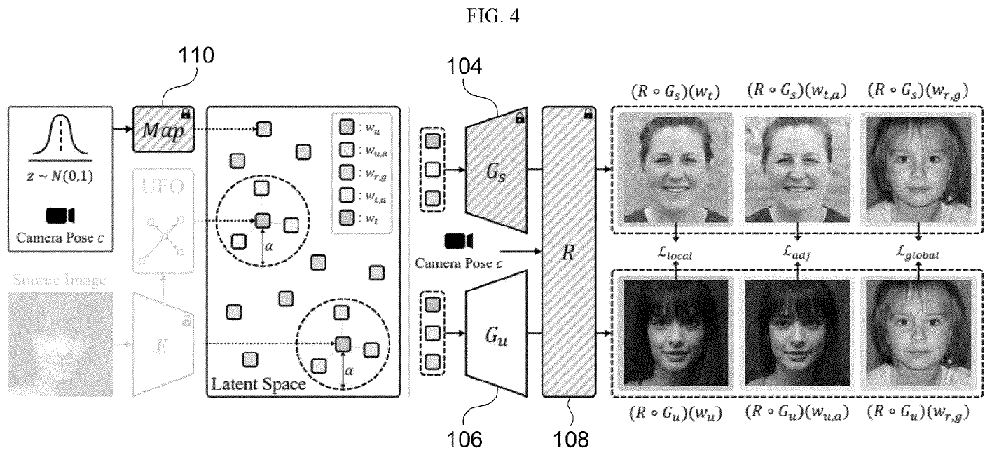

FIG. 2 is a diagram showing an overall framework for performing unlearning of prescribed people in a pre-learned generative model according to one example of the present invention, and FIG. 3 is a diagram showing a part related to the un-identifying process among the overall framework of FIG. 2, and FIG. 4 is a diagram showing a part related to the latent target unlearning process among the overall framework of FIG. 2.

At first, referring to FIG. 2 and FIG. 3, the un-identifying process will be described. A source image may be inputted into the computing device (12). The source image is an image including a face of a person to be unlearned in a pre-learned generative model. The computing device (12) may extract a source latent vector in a latent space by inputting the source image into the encoder (102).

In one example, the encoder (102) may be a neural network for inverse transformation of the first generator (104), which is the pre-learned generative model. In other words, if the first generator (104) generates an image based on a latent vector in a latent space, the inverse transformation may be a process of extracting the latent vector of the corresponding image when there is an image. When the first generator (104) is GAN (Generative Adversarial Network), the encoder (102) may be a neural network for GAN inverse transformation.

The computing device (12) may set a source latent vector extracted from a source image and a target latent vector in the latent space based on a mean latent vector. Herein, the mean latent vector may refer to the mean of latent vectors in the latent space extracted by the encoder (102). For example, the mean of latent vectors for each sample image extracted from the encoder (102) after inputting a plurality of sample images into the encoder (102) may be referred to as the mean latent vector.

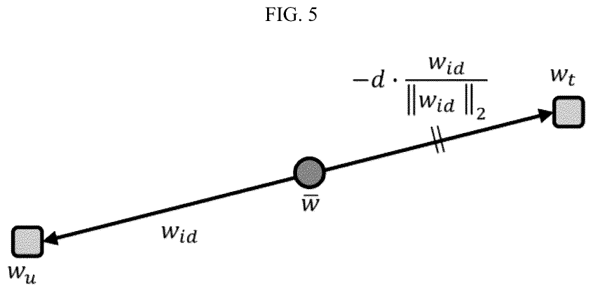

FIG. 5 is a diagram illustrating a state of setting a target latent vector based on a mean latent vector and a source latent vector in a latent space in one example of the present invention. Referring to FIG. 5, when the source latent vector (wᵤ) is extracted from a source image, the computing device (12) may calculate an identity latent vector (w_{id}) for the corresponding person by a difference between the source latent vector (wᵤ) and the mean latent vector (w̅) in the latent space. In other words, w_{id}=wᵤ−w̅. Herein, the identity latent vector (w_{id}) may head from the mean latent vector (w̅) to the source latent vector (wᵤ), and have a size corresponding to the distance between the source latent vector (wᵤ) and the mean latent vector (w̅) in the latent space.

The computing device (12) may set the target latent vector (wₜ) in the opposite direction to the identity latent vector (w_{id}) based on the mean latent vector (w̅) in the latent space. Then, the position of the target latent vector (wₜ) based on the mean latent vector (w̅) may be determined based on the length of the identity latent vector (w_{id}). In other words, the target latent vector (wₜ) may be set through extrapolation between the source latent vector (wᵤ) and the mean latent vector (w̅) via the mean latent vector (w̅) as a stopover. Through this, it may be possible that the distance between the source latent vector (wᵤ) and the target latent vector (wₜ) in the latent space is spaced apart sufficiently by a certain distance.

Then, the process of going form the source latent vector (wᵤ) to the mean latent vector (w̅) may be a process of erasing the identity of the corresponding person (De-identification process), and the process of going from the mean latent vector (w̅) to the target latent vector (wₜ) may be a process of coating a completely different identity on the corresponding person (En-identification process).

In one example, the target latent vector (wₜ) may be set by the following equation 1.

$${w}_{t} = \overline{w} - d \cdot \frac{{w}_{id}}{{‖ {w}_{id} ‖}_{2}} \qquad ( Equation 1 )$$

d: Pre-set distance control parameter
∥w_{id}∥₂: 2-norm distance (L2-norm) of identity latent vector

In Equation 1, the distance control parameter (d) is a parameter for controlling how much of a new identity is coated to the corresponding person.

On the other hand, referring to FIG. 2, the latent target unlearning process may include a process of applying a local unlearning loss (L_{local}), an adjacency-aware unlearning loss (L_{adj}), and a global preservation loss (L_{global}). Hereinafter, “loss” and “loss function” may be used as the same meaning. In other words, in the disclosed examples, “loss” and “loss function” may be used interchangeably.

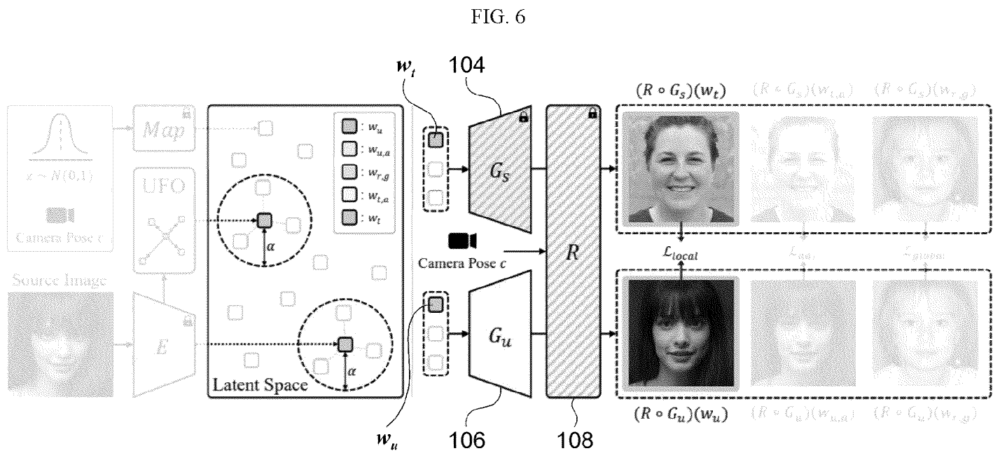

FIG. 6 is a diagram showing a state of applying a local unlearning loss (L_{local}) in one example of the present invention. Referring to FIG. 6, the computing device (12) may input the target latent vector (wₜ) as the first generator (104), and input the source latent vector (wᵤ) as the second generator (106), respectively. The first generator (104) is a pre-learned generative model, and in the process of performing unlearning, the values of the neural network parameters in the generative model remain in a fixed state.

Herein, the second generator (106) is a separate generative model for performing unlearning of a specific person in the first generator (104), which is a pre-learned generative model. The initial values of the neural network parameters of the second generator (106) may be the same as the values of the neural network parameters of the first generator (104) in which learning is completed. In other words, the second generator (106) is a generative model having the same neural network parameters as the first generator (104) in which learning is completed, and may be a model in which unlearning is performed for a specific person.

The neural network parameters of the second generator (106) may be updated in the process of performing unlearning depending on the local unlearning loss (L_{local}), adjacency-aware unlearning loss (L_{adj}), and global preservation loss (L_{global}) described below. Due to this, the second generator (106) performs unlearning on the person included in the source image.

The first generator (104) may receive input of the target latent vector (wₜ) and output a specific map corresponding to a target generated image (target feature map). The target feature map outputted from the first generator (104) may be inputted into the rendering model (108). The rendering model (108) may output a target generated image corresponding to the target feature map (expressed as (R·G_{S})(wₜ) in FIG. 2 and FIG. 6) based on the target feature map. In other words, the target generated image is an image generated from the target latent vector (wₜ), and may be an image shown as the person targeted for unlearning is converted into another person (a person having an identity different from the person targeted for unlearning.

The second generator (106) may output a feature map corresponding to a source generated image (source feature map) by receiving input of the source latent vector (wᵤ). The source feature map outputted from the second generator (106) may be inputted into the rendering model (108). The rendering model (108) may output a source generated image corresponding to the source feature map (expressed as (R·Gᵤ)(wᵤ) in FIG. 2 and FIG. 6) based on the source feature map. Herein, the source generated image is an image generated from the source latent vector (wᵤ), and may be an image of a person having the same identity as the person targeted for unlearning.

The rendering model (108) may generate a target generated image and a source generated image from the target feature map and the source feature map, respectively, by receiving input of camera pose information.

Herein, the local unlearning loss (L_{local}) may be to make the target feature map and source feature map similar, and make the target generated image and source generated image similar. In one example, the local unlearning loss may include a first local-related loss that makes the target feature map and source feature map similar, a second local-related loss that makes the target generated image and the source generated image perceptually similar, and a third local-related loss that makes the identities of the target generated image and source generated image similar.

In one example, to the first local-related loss, a loss according to the L2 distance between the target feature map and the source feature map may be applied. To the second local-related loss, a perceptual loss between the target generated image and the source generated image may be applied. To the third local-related loss, an identity loss between the target generated image and the source generated image may be applied.

The computing device (12) may learn the second generator (106) to have a local unlearning loss function according to the following Equation 2. According to this local unlearning loss function, by effectively changing an image corresponding to a source latent vector into an image corresponding to a target latent vector in the second generator (106), unlearning for an image identical to the corresponding person can be performed in the second generator (106).

$${ℒ}_{local} ( {\hat{x}}_{u} , {\hat{x}}_{t} ) = {λ}_{L 2} {ℒ}_{L 2} ( {F}_{u} , {F}_{t} ) + {λ}_{per} {ℒ}_{per} ( {\hat{x}}_{u} , {\hat{x}}_{t} ) + {λ}_{id} {ℒ}_{id} ( {\hat{x}}_{u} , {\hat{x}}_{t} ) \qquad ( Equation 2 )$$

Fᵤ: Source feature map
Fₜ: Target feature map
\hat{x}ᵤ: Source generated image
\hat{x}ₜ: Target generated image
[symbol] _{L2}(Fᵤ, Fₜ): First local-related loss
[symbol] ₚₑᵣ(\hat{x}ᵤ, \hat{x}ₜ): Second local-related loss
[symbol] _{id} (\hat{x}ᵤ, \hat{x}ₜ): Third local-related loss
λ_{L2}: Weighted value of the first local-related loss
λₚₑᵣ: Weighted value of the second local-related loss
λ_{id}: Weighted value of the third local-related loss

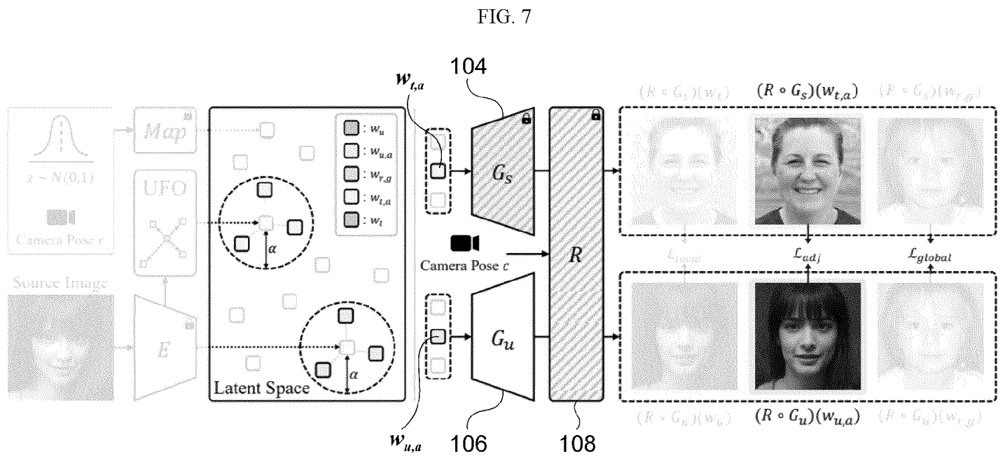

FIG. 7 is a diagram showing a state of applying an adjacency-aware unlearning loss (L_{adj}) in one example of the present invention. The adjacency-aware unlearning loss is to perform unlearning even on an image that have the same identity as the person of the source image, but differs from the source image in everything else that maintains the identity such as expression or clothing as the person of the source image.

For this, referring to FIG. 7, the computing device (12) may extract one or more source peripheral latent vectors (w_{u,a}) adjacent to the source latent vector (wᵤ), and extract one or more target peripheral latent vectors (w_{t,a}) adjacent to the target latent vector (wₜ), respectively, in the latent space.

In one example, the computing device (12) may extract a latent vector present in the maximal radius (αₘₐₓ) pre-set based on the source latent vector (wᵤ) as the source peripheral latent vector (w_{u,a}) in the latent space. In addition, the computing device (12) may extract a latent vector present in the maximal radius (αₘₐₓ) pre-set based on the target latent vector (wₜ) as the target peripheral latent vector (w_{t,a}) in the latent space.

In one example, the computing device (12) may use a random latent vector by random noise, to extract the source peripheral latent vector (w_{u,a}) and target peripheral latent vector (w_{t,a}) in the latent space. In other words, the computing device (12) may extract a random latent vector from random noise in the latent space by inputting random noise (z˜N(0,1)) into a mapping network (110). Then, the random noise may be Gaussian noise, but not limited thereto.

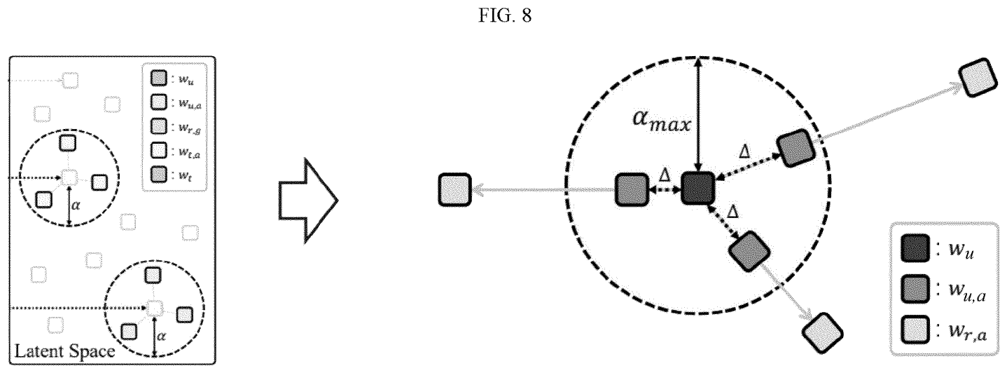

FIG. 8 is a diagram showing a state of extracting a source peripheral latent vector using a random latent vector in a latent space according to one example of the present invention. Herein, extracting the source peripheral latent vector is described, but the target peripheral latent vector may also be extracted by the same method.

Referring to FIG. 8, the computing device (12) may calculate the directions to the random latent vectors (w_{r,a}) present in the surroundings thereof based on the source latent vector (wᵤ) in the latent space, respectively. The computing device (12) may extract the source peripheral latent vector (w_{u,a}) located at a prescribed distance (Δ) based on the source latent vector (wᵤ) by scaling within the maximal radius (αₘₐₓ) pre-set in the calculated direction in the source latent vector (wᵤ). Herein, w_{u,a}=wᵤ+Δ. The maximal radius (αₘₐₓ) may be set in the line of maintaining the identity of the person corresponding to the source latent vector (wᵤ). The distance (Δ) to calculate the source peripheral latent vector (w_{u,a}) based on the source latent vector (wᵤ) may be calculated through the following Equation 3.

$$Δ = {\{ {α}^{i} \cdot \frac{{w}_{r , a}^{i} - {w}_{u}}{{‖ {w}_{r , a}^{i} - {w}_{u} ‖}_{2}} \}}_{i = 1}^{{N}_{a}} \qquad ( Equation 3 )$$

Nₐ: Total number of random latent vectors
i: Index of random latent vectors
αⁱ: Scale parameter

The scale parameter (αⁱ) may be sampled in from a uniform distribution having αⁱ˜ [symbol] (0, αₘₐₓ). In addition, the target peripheral latent vector (w_{t,a}) may be extracted based on the target latent vector (wₜ) by the same method. A plurality of the source peripheral latent vectors (w_{u,a}) and the target peripheral latent vectors (w_{t,a}) may be extracted depending on the number of the random latent vectors.

The computing device (12) may enable to output a target peripheral feature map by inputting each target peripheral latent vector (w_{t,a}) as the first generator (104), and enable to output a target peripheral generated image by inputting each target peripheral feature map into the rendering model (108). In addition, the computing device (12) may enable to output a source peripheral feature map by inputting each source peripheral latent vector (w_{u,a}) as the second generator (106), and enable to output a source peripheral generated image by inputting each source peripheral feature map into the rendering model (108).

Herein, the adjacency-aware unlearning loss (L_{adj}) may be to make each target peripheral feature map and source peripheral feature map similar, and to make each target peripheral generated image and source peripheral generated image similar. Then, the adjacency-aware unlearning loss may include a first adjacency-related loss to make the target peripheral feature map and source peripheral feature map similar, a second adjacency-related loss to make the target peripheral generated image and source peripheral generated image perceptually similar, and a third adjacency-related generated loss to make identities of the target peripheral generated image and source peripheral generated image similar, as same as the local unlearning loss.

In other words, the adjacency-aware unlearning loss is same as calculating a mean of local unlearning losses for a plurality of source peripheral latent vectors and target peripheral latent vectors. Accordingly, the adjacency-aware unlearning loss (L_{adj}) may be represented by the following Equation 4.

$${ℒ}_{adj} ( {w}_{u} , {w}_{t} ) = \frac{1}{{N}_{a}} {\sum }_{i = 1}^{{N}_{a}} {ℒ}_{local} ( {\hat{x}}_{u , a}^{i} , {\hat{x}}_{t , a}^{i} ) \qquad ( Equation 4 )$$

Nₐ: Total number of random latent vectors
i: Index of random latent vectors
\hat{x}ⁱ_{u,a}: i-th source peripheral generated image
\hat{x}ⁱ_{t,a}: i-th target peripheral generated image

Herein,

$${\hat{x}}_{u , a}^{i} = R ( {F}_{u , a}^{i} ) , and {\hat{x}}_{t , a}^{i} = R ( {F}_{t , a}^{i} ) .$$

R represents the rendering model (108), and Fⁱ_{u,a} is the i-th source peripheral feature map, and Fⁱ_{t,a} is the i-th target peripheral feature map.

According to this adjacency-aware unlearning loss function, by effectively changing an image corresponding to a source peripheral latent vector into a target peripheral latent vector in the second generator (106), unlearning on an image that have the same identity as the corresponding person, but differs in everything else that maintains the identity such as expression or clothing as the person may be performed in the second generator (106).

On the other hand, the identity of a specific person may be deleted from the second generator (106) by the local unlearning loss and adjacency-aware unlearning loss, but there is a concern that the performance of the pre-learned generative model may deteriorate. Accordingly, in the disclosed example, in order to reduce the performance deterioration of the pre-learned generative model, the global preservation loss may be applied.

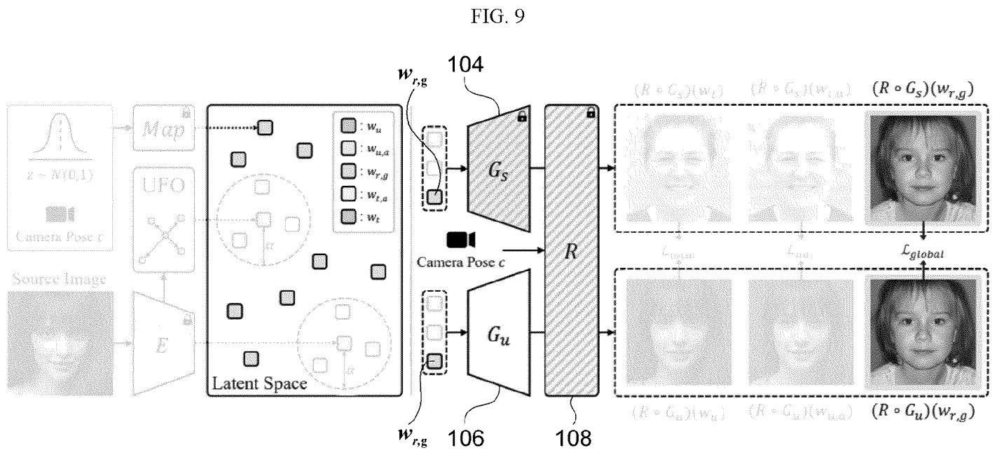

FIG. 9 is a diagram showing a state of applying a global preservation loss) (L_{global}) in one example of the present invention. Referring to FIG. 9, the computing device (12) may extract random latent vectors (w_{r,g}) unrelated to (far enough to) the source latent vector (wᵤ) and target latent vector (wₜ) among the random latent vectors in the latent space. In one example, the random latent vectors (w_{r,g}) may be random latent vectors outside the maximal radius (αₘₐₓ) range pre-set based on the source latent vector (wᵤ) and the target latent vector (wₜ), respectively.

The computing device (12) may input the extracted random latent vectors (w_{r,g}) as the first generator (104) and the second generator (106), respectively. The random latent vectors (w_{r,g}) may pass through the first generator (104) and the rendering model (108) and be outputted as a first random generated image (expressed as (R·G_{S})(w_{r,g}) in FIG. 2 and FIG. 9). In addition, the random latent vectors (w_{r,g}) may pass through the second generator (106) and the rendering model (108) and be outputted as a second random generated image (Expressed as (R·Gᵤ) (w_{r,g}) in FIG. 2 and FIG. 9).

Herein, the global preservation loss (L_{global}) may be to make the first random generated image and the second random generated image perceptually similar. The global preservation loss (L_{global}) may be represented by the following Equation 5.

$${ℒ}_{global} ( {G}_{u} , {G}_{s} ) = \frac{1}{{N}_{a}} {\sum }_{i = 1}^{{N}_{g}} {ℒ}_{per} ( {\hat{x}}_{u , g}^{i} , {\hat{x}}_{s , g}^{i} ) \qquad ( Equation 5 )$$

N_{g}: Total number of random latent vectors unrelated to source latent vector and target latent vector
i: Index of random latent vectors unrelated to source latent vector and target latent vector
\hat{x}ⁱ_{s,g}: i-th first random generated image
\hat{x}ⁱ_{u,g}: i-th second random generated image
Gₛ: First generator
Gᵤ: Second generator

In one example, the total loss function (Lₜₒₜₐₗ) according to the latent target unlearning process may be represented by the following Equation 6.

$${ℒ}_{total} = {ℒ}_{local} + {λ}_{adj} {ℒ}_{adj} + {λ}_{global} {ℒ}_{global} \qquad ( Equation 6 )$$

λ_{adj}: Weighted value according to adjacency-aware unlearning loss
λ_{global}: Weighted value according to global preservation loss

On the other hand, herein, it is described that a total of 3 kinds of loss functions are applied in the latent target unlearning process, but not limited thereto, and only the local unlearning loss function may be applied, and the local unlearning loss function and adjacency-aware unlearning loss function may be applied.

According to the disclosed example, the identity of the person included in the source image may be deleted in a pre-learned generative model only by one source image. Then, an image with a different facial expression or style while maintaining the identity of the corresponding person may also be unlearned, and at the same time, the performance of the pre-learned generative model can be maintained.

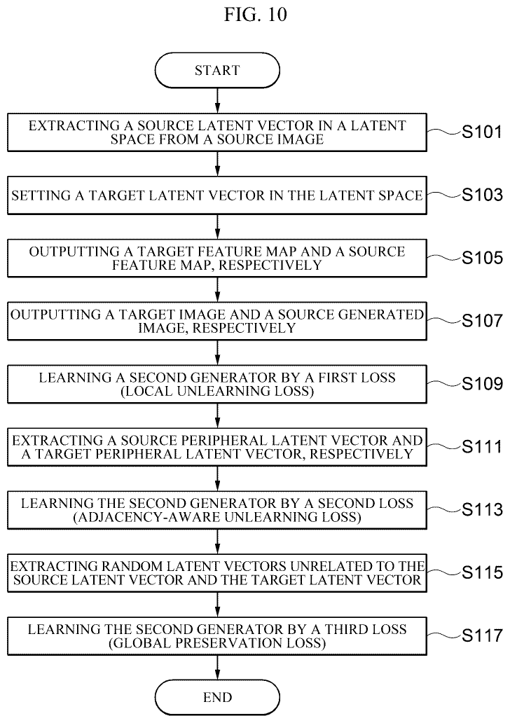

FIG. 10 is a flowchart to describe the method of performing unlearning of people in a pre-learned generative model according to one example of the present invention. In the illustrated flowchart, the method is described by dividing the method into a plurality of steps, but at least some steps may be performed by changing the order, be performed together as combined with another step, be omitted, be performed as divided into detailed steps, or be performed by adding one or more steps that are not shown.

Referring to FIG. 10, the computing device (12) may extract a source latent vector in a latent space by inputting a source image including a face of a person to be unlearned into an encoder (102) (S 101).

Next, the computing device (12) may set a target latent vector so that the identity is different from the person corresponding to the source latent vector in the latent space (S 103). In one example, the computing device (12) may obtain a mean latent vector in the latent space, and set the target latent vector based on the source latent vector and the mean latent vector.

Next, the computing device (12) may output a target feature map by inputting the target latent vector into the first generator (104) which is a pre-learned generative model, and output a source feature map by inputting the source latent vector into the second generator (106) (S 105).

Next, the computing device (12) may output a target generated image and a source generated image, respectively, by inputting a target feature map and a source feature map into a rendering model, respectively (S 107).

Next, the computing device (12) may learn the second generator (106) by a first loss (i.e., local unlearning loss) pre-set based on the target feature map, source feature map, target generated image, and source generated image (S 109).

Next, the computing device (12) may extract one or more source peripheral latent vectors adjacent to the source latent vector, and extract one or more target peripheral latent vectors adjacent to the target latent vector, in the latent space (S 111).

In one example, the computing device (12) may extract random latent vectors from random noise, extract source peripheral latent vectors based on the random latent vector and the source latent vector, and extract target peripheral latent vectors based on the random latent vector and the target latent vector.

Next, the computing device (12) may learn the second generator (106) by a pre-set second loss (i.e., adjacency-aware unlearning loss) based on the source peripheral latent vectors and the target peripheral latent vectors (S 113).

Next, the computing device (12) may extract random latent vectors unrelated to the source latent vector and the target latent vector among the random latent vectors from random noise (S 115).

Next, the computing device (12) may learn the second generator (106) by a pre-set third loss (i.e., global preservation loss) based on the random latent vector unrelated to the source latent vector and target latent vector S 117).

Representative examples of the present invention have been described in detail above, but those skilled in the art will understand that various modifications can be made to the afore-mentioned examples without departing from the scope of the present invention. Therefore, the scope of the present invention should not be limited to the described examples, and should be determined not only by the claims described below but also by equivalents of these claims.

What is claimed is:

1. A method of performing unlearning of people in a generative model, the method performed in a computing device equipped with one or more processors and a memory storing one or more programs executed by the one or more processors, the method comprising:
inputting a source image including a face of a person to be unlearned in a pre-learned generative model into an encoder to extract a source latent vector in a latent space;
setting a target latent vector so that the identity is different from that of a person corresponding to the source latent vector in the latent space; and
performing unlearning to remove the identity of the person in the pre-learned model based on the source latent vector and the target latent vector.

2. The method according to claim 1, wherein the setting comprises:
obtaining a mean latent vector in the latent space by the encoder; and
setting a target latent vector based on the source latent vector and the mean latent vector.

3. The method according to claim 2, wherein the setting comprises:
calculating an identity latent vector for the person by a difference between the source latent vector and the mean latent vector in the latent space; and
setting a target latent vector in the opposite direction to the direction of the identity latent vector based on the mean latent vector.

4. The method according to claim 3, wherein the target latent vector (wₜ) is set by the following equation:
$${w}_{t} = \overline{w} - d \cdot \frac{{w}_{id}}{{‖ {w}_{id} ‖}_{2}} \qquad [ Equation ]$$
wherein w̅ is a mean latent vector;
d is a pre-set distance control parameter;
w_{id} is an identity latent vector; and
∥w_{id}∥₂ is 2-norm distance (L2-norm) of identity latent vector.

5. The method according to claim 1, wherein the performing of the unlearning comprises:
inputting the target latent vector into a first generator, which is a pre-learned generative model to output a target feature map;
inputting the source latent vector into a second generator to output a source feature map;
inputting the target feature map and the source feature map into a rendering model, respectively, to output a target generated image and a source generated image, respectively; and
learning the second generator by a first loss pre-set based on the target feature map, the source feature map, the target generated image, and the source generated image,
wherein the initial values of neural network parameters of the second generator are set as same as values of neural network parameters of the learned first generator.

6. The method according to claim 5, wherein the first loss is a local unlearning loss, and
the first loss comprises:
a first local-related loss that makes the target feature map and the source feature map similar;
a second local-related loss that makes the target generated image and the source generated image perceptually similar; and
a third local-related loss that makes the identities of the target generated image and the source generated image similar.

7. The method according to claim 6, wherein the local unlearning loss (L_{local}) is represented by the following equation:
$${ℒ}_{local} ( {\hat{x}}_{u} , {\hat{x}}_{t} ) = {λ}_{L 2} {ℒ}_{L 2} ( {F}_{u} , {F}_{t} ) + {λ}_{per} {ℒ}_{per} ( {\hat{x}}_{u} , {\hat{x}}_{t} ) + {λ}_{id} {ℒ}_{id} ( {\hat{x}}_{u} , {\hat{x}}_{t} ) \qquad [ Equation ]$$
wherein Fᵤ is a source feature map;
Fₜ is a target feature map;
\hat{x}ᵤ is a source generated image;
\hat{x}ₜ is a target generated image; [symbol]
_{L2}(Fᵤ, Fₜ) is a first local-related loss; [symbol]
ₚₑᵣ(\hat{x}ᵤ, \hat{x}ₜ) is a second local-related loss; [symbol]
_{id}(\hat{x}ᵤ, \hat{x}ₜ) is a third local-related loss;
λ_{L2} is a weighted value of the first local-related loss;
λₚₑᵣ is a weighted value of the second local-related loss; and
λ_{id} is a weighted value of the third local-related loss.

8. The method according to claim 5, wherein the performing of the unlearning further comprises:
extracting one or more source peripheral latent vectors adjacent to the source latent vector in the latent space, and extracting one or more target peripheral latent vectors adjacent to the target latent vector; and
learning the second generator by a second loss pre-set based on the source peripheral latent vector and the target peripheral latent vector.

9. The method according to claim 8, wherein the learning of the second generator comprises:
inputting each of the target peripheral latent vectors into the first generator to output a target peripheral feature map, respectively;
inputting each of the source peripheral latent vectors into the second generator to output a source peripheral feature map, respectively;
inputting each of the target peripheral feature map into the rendering model to output a target peripheral generated image, respectively; and
inputting each of the source peripheral feature map into the rendering model to output a source peripheral generated image, respectively.

10. The method according to claim 9, wherein the second loss is an adjacency-aware unlearning loss; and
the second loss comprises:
a first adjacency-related loss that makes the target peripheral feature map and the source peripheral feature map similar;
a second adjacency-related loss that makes the target peripheral generated image and the source peripheral feature map similar; and
a third adjacency-related loss that makes the identities of the target peripheral generated image and the source peripheral generated image similar.

11. The method according to claim 8, wherein the performing of the unlearning further comprises:
extracting random latent vectors from random noise in the latent space; and
the extracting of the one or more source peripheral latent vectors is extracting source peripheral latent vectors by scaling within a pre-set maximum radius in each direction to random latent vectors based on the source latent vector, and
the extracting of the one or more target peripheral latent vectors is extracting target peripheral latent vectors by scaling within a pre-set maximum radius in each direction to random latent vectors based on the target latent.

12. The method according to claim 11, wherein the performing of the unlearning further comprises:
extracting random latent vectors unrelated to the source latent vector and the target latent vector among the random latent vectors of the latent space; and
learning the second generator by a third loss pre-set based on the random latent vectors unrelated to the source latent vector and the target latent vector.

13. The method according to claim 12, wherein the learning of the second generator comprises:
outputting a first random generated image by making the unrelated random latent vector pass through the first generator and the rendering model; and
outputting a second random generated image by making the unrelated random latent vector pass through the second generator and the rendering model.

14. The method according to claim 13, wherein the third loss is a global preservation loss; and
the third loss is a loss that makes the first random generated image and the second random generated image perceptually similar.

15. A computing device comprising:
one or more processors;
a memory; and
one or more programs stored in the memory, the one or more programs configured to be executed by the one or more processors, the one or more programs comprising:
an instruction to input a source image comprising a face of a person to be unlearned in a pre-learned generative model into an encoder to output a source latent vector in the latent space;
an instruction to set a target latent vector so that the identity is different from the person corresponding to the source latent vector in the latent space; and
an instruction to perform unlearning to remove the identity of the person in the pre-learned model based on the source latent vector and the target latent vector.

16. The computing device according to claim 15, wherein the instruction to perform unlearning comprises:
an instruction to input the target latent vector into a first generator, which is a pre-learned generative model to output a target feature map;
an instruction to input the source latent vector into a second generator to output a source feature map;
an instruction to input the target feature map and the source feature map into a rendering model, respectively, to output a target generated image and a source generated image, respectively;
an instruction to learn the second generator by a first loss pre-set based on the target feature map, the source feature map, the target generated image, and the source generated image, and
the initial values of neural network parameters of the second generator are set as same as values of neural network parameters of the learned first generator.

17. The computing device according to claim 16, wherein the instruction to perform unlearning further comprises:
an instruction to extract one or more source peripheral latent vectors adjacent to the source latent vector in the latent space, and to extract one or more target peripheral latent vectors adjacent to the target latent vector; and
an instruction to learn the second generator by a second loss pre-set based on the source peripheral latent vector and the target peripheral latent vector.

18. The computing device according to claim 16, wherein the instruction to perform unlearning further comprises:
an instruction to extract random latent vectors in the latent space from random noise;
an instruction to extract random latent vectors unrelated to the source latent vector and the target latent vector among the random latent vectors of the latent space; and
an instruction to learn the second generator by a third loss pre-set based on the random latent vectors unrelated to the source latent vector and the target latent vector.

19. A computer program stored in a non-transitory computer readable storage medium, the computer program comprising one or more instructions, the instructions, when executed by a computing device having one or more processors, making the computing device to perform:
inputting a source image comprising a face of a person to be unlearned in a pre-learned generative model into an encoder to extract a source latent vector in a latent space;
setting a target latent vector so that the identity is different from that of a person corresponding to the source latent vector in the latent space; and
performing unlearning to remove the identity of the person in the pre-learned model based on the source latent vector and the target latent vector.
